(19) United States
(12) Patent Application Publication
(10) Pub. No.: US 2025/0236482 A1
(43) Pub. Date: Jul. 24, 2025

(54) SHEET DISCHARGING APPARATUS AND IMAGE FORMING APPARATUS

(71) Applicant: CANON KABUSHIKI KAISHA, Tokyo (JP)

(72) Inventor: AKINORI YOKOTA, Tokyo (JP)

(21) Appl. No.: 19/021,949

(22) Filed: Jan. 15, 2025

(30) Foreign Application Priority Data
Jan. 19, 2024 (JP) 2024-007090
Dec. 9, 2024 (JP) 2024-214478

(51) Int. Cl. B65H 29/12; G03G 15/00

(52) U.S. Cl. CPC B65H 29/125; G03G 15/6552; G03G 15/6579; B65H 2301/44318; B65H 2404/1121; B65H 2404/143

(57) ABSTRACT

A sheet discharging apparatus includes a supporting portion, a first roller, and a second roller. The circumference surface includes a first end, and a second end. In a state where a rotation radius of the circumference surface at the first end is referred to as a first radius, a rotation radius of the circumference surface at the second end is referred to as a second radius, a rotation radius of the first surface is referred to as a third radius, and a rotation radius of the second surface is referred to as a fourth radius, (i) the circumference surface is inclined with respect to the second axial direction such that the first radius is greater than the second radius, (ii) the third radius is greater than the first radius, and (iii) the fourth radius is smaller than the second radius.

### BACKGROUND OF THE INVENTION

### Field of the Invention

The present invention relates to a sheet discharging apparatus for discharging sheets, and an image forming apparatus equipped with the same.

### Description of the Related Art

Hitherto, a sheet discharge roller pair that is composed of a first roller and a second roller and that discharges sheets to an exterior of an image forming apparatus has been proposed (refer to Japanese Patent Application Laid-Open Publication No. 2013-147324). The first roller includes a cylindrical portion that comes into pressure contact with the second roller, and a flange portion, and on an outer circumference portion of the flange portion are formed a plurality of projecting portions. The plurality of projecting portions are provided to push a trailing edge of the sheet being discharged by the first roller and the second roller toward a discharge portion, and are formed at a diameter equal to or smaller than a radius of the cylindrical portion of the first roller.

However, if the first roller is inclined with respect to the second roller such that the projecting portions approximate the second roller, the projecting portions may protrude toward an outer side in the radial direction with respect to the cylindrical portion of the first roller. If the projecting portions is protruded greatly with respect to the cylindrical portion, the sheets may be damaged.

### SUMMARY OF THE INVENTION

According to a first aspect of the present invention, a sheet discharging apparatus includes a supporting portion configured to support a sheet, a first roller configured to rotate about a first rotational axis extending in a first axial direction, and a second roller configured to rotate about a second rotational axis extending in a second axial direction and configured to discharge the sheet, together with the first roller, toward the supporting portion. The second roller includes a first surface that extends in a direction intersecting a virtual circle having the second rotational axis as a center when viewed in the second axial direction, the first surface being configured to push the sheet toward the supporting portion, a second surface that extends in a direction intersecting a virtual circle having the second rotational axis as the center when viewed in the second axial direction, the second surface being configured to push the sheet toward the supporting portion, and a roller portion that is arranged between the first surface and the second surface in the second axial direction, and that includes a circumference surface configured to abut against the first roller such that a discharge nip is formed with the first roller. The circumference surface includes a first end, and a second end opposite to the first end in the second axial direction. A distance between the first end and the first surface in the second axial direction is shorter than a distance between the second end and the first surface in the second axial direction. In a state where a rotation radius of the circumference surface at the first end is referred to as a first radius, a rotation radius of the circumference surface at the second end is referred to as a second radius, a rotation radius of the first surface is referred to as a third radius, and a rotation radius of the second surface is referred to as a fourth radius, (i) the circumference surface is inclined with respect to the second axial direction such that the first radius is greater than the second radius, (ii) the third radius is greater than the first radius, and (iii) the fourth radius is smaller than the second radius.

According to a second aspect of the present invention, a sheet discharging apparatus includes a supporting portion configured to support a sheet, a first roller configured to rotate about a first rotational axis extending in a first axial direction, and a second roller configured to rotate about a second rotational axis extending in a second axial direction and configured to discharge the sheet toward the supporting portion together with the first roller. The second roller includes a pushing surface that extends in a direction intersecting a virtual circle having the second rotational axis as a center when viewed in the second axial direction, the pushing surface being configured to push the sheet toward the supporting portion, and a roller portion that is arranged at a position different from the pushing surface in the second axial direction, and that includes a circumference surface configured to abut against the first roller such that a discharge nip is formed with the first roller. The circumference surface includes a first end, and a second end opposite to the first end in the second axial direction. A distance between the first end and the pushing surface in the second axial direction is shorter than a distance between the second end and the pushing surface in the second axial direction. In a state where a rotation radius of the circumference surface at the first end is referred to as a first radius, and a rotation radius of the circumference surface at the second end is referred to as a second radius, (i) the circumference surface is inclined with respect to the second axial direction such that the first radius is greater than the second radius, and (ii) a rotation radius of the pushing surface is greater than the first radius.

According to a third aspect of the present invention, a sheet discharging apparatus includes a supporting portion configured to support a sheet, a first roller configured to rotate about a first rotational axis extending in a first axial direction, and a second roller configured to rotate about a second rotational axis extending in a second axial direction and configured to discharge the sheet toward the supporting portion together with the first roller. The second roller includes a pushing surface that extends in a direction intersecting a virtual circle having the second rotational axis as a center when viewed in the second axial direction, the pushing surface being configured to push the sheet toward the supporting portion, and a roller portion that is arranged at a position different from the pushing surface in the second axial direction, and that includes a circumference surface configured to abut against the first roller such that a discharge nip is formed with the first roller. The circumference surface includes a first end, and a second end opposite to the first end in the second axial direction. A distance between the first end and the pushing surface in the second axial direction is longer than a distance between the second end and the pushing surface in the second axial direction. In a state where a rotation radius of the circumference surface at the first end is referred to as a first radius, and a rotation radius of the circumference surface at the second end is referred to as a second radius, (i) the circumference surface is inclined with respect to the second axial direction such that the first radius is greater than the second radius, and (ii) a rotation radius of the pushing surface is smaller than the second radius.

Further features of the present invention will become apparent from the following description of exemplary embodiments with reference to the attached drawings.

### BRIEF DESCRIPTION OF THE DRAWINGS

FIG. 1 is an entire schematic diagram illustrating an image forming apparatus according to a first embodiment.

FIG. 2A is a cross-sectional view illustrating a state in which a sheet is discharged toward a sheet discharge tray.

FIG. 2B is a cross-sectional view illustrating a state in which a sheet is conveyed toward a duplex conveyance path.

FIG. 3 is a front view illustrating a sheet discharge roller pair.

FIG. 4A is a left side view illustrating a driven roller, and a partially enlarged view thereof.

FIG. 4B is a front view illustrating the driven roller.

FIG. 4C is a right side view illustrating the driven roller, and a partially enlarged view thereof.

FIG. 5 is a view illustrating a peripheral speed of the driven roller and a conveyance speed of a sheet.

FIG. 6 is a front view illustrating an orientation of the driven roller in a state where a sheet is conveyed.

FIG. 7A is a left side view illustrating a driven roller according to a second embodiment, and a partially enlarged view thereof.

FIG. 7B is a front view illustrating the driven roller.

FIG. 7C is a right side view illustrating the driven roller.

FIG. 8A is a left side view illustrating a driven roller according to a third embodiment.

FIG. 8B is a front view illustrating the driven roller.

FIG. 8C is a right side view illustrating the driven roller, and a partially enlarged view thereof.

FIG. 9A is a left side view illustrating a driven roller according to a fourth embodiment, and a partially enlarged view thereof.

FIG. 9B is a front view illustrating the driven roller.

FIG. 9C is a right side view illustrating the driven roller, and a partially enlarged view thereof.

FIG. 10 is a view illustrating a positional relationship of four driven rollers.

### DESCRIPTION OF THE EMBODIMENTS

### First Embodiment

### Entire Configuration

At first, a first embodiment of the present disclosure will be described. An image forming apparatus 100 according to the present embodiment is a monochrome laser beam printer adopting an electrophotographic system. The image forming apparatus refers to an apparatus that forms an image on a sheet serving as a recording medium based on an image information entered from an external PC or an image information read from a document, and includes a printer, a copying machine, a facsimile, and a multifunction device. Further, in addition to a main body that has an image forming function, the image forming apparatus may have auxiliary devices such as an option feeder, an image reading apparatus, and a sheet processing apparatus connected thereto, wherein the entire system to which the auxiliary device is attached is one type of an image forming apparatus.

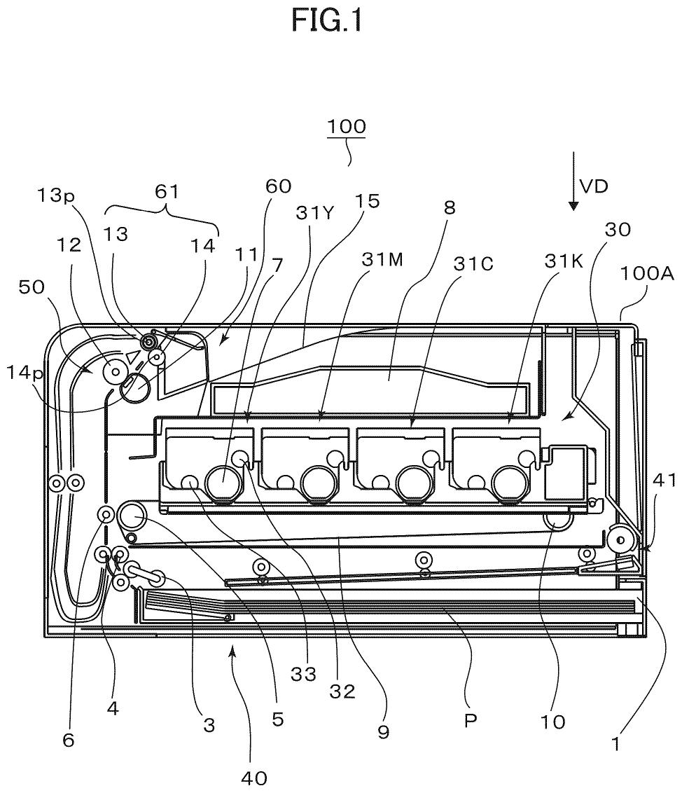

The image forming apparatus 100 includes, as illustrated in FIG. 1, an image forming unit 30 for forming images on sheets P, a sheet feeding unit 40, a fixing unit 50, and a sheet discharging apparatus 60. The image forming unit 30 includes four process cartridges 31Y, 31M, 31C, and 31K for forming toner images of four colors, which are yellow (Y), magenta (M), cyan (C), and black (K), and a laser scanner 8.

The four process cartridges 31Y, 31M, 31C, and 31K adopt the same configuration, except for the difference in the colors of the images being formed. Therefore, only the configuration and image forming processes of the process cartridge 31Y will be descried, and the descriptions of process cartridges 31M, 31C, and 31K are omitted.

The process cartridge 31Y includes a photosensitive drum 7, a charging roller 32, and a developing roller 33. The photosensitive drum 7 serving as a photosensitive member is composed by applying an organic photoconductive layer on an outer circumference of an aluminum cylinder, and is rotated by a drive motor not shown. A photosensitive belt may be used instead of the photosensitive drum 7. Further, the image forming unit 30 is provided with an intermediate transfer belt 9 wound around a driving roller 5 or a tension roller 10, and the intermediate transfer belt 9 is rotated in a clockwise direction in the drawing by the driving roller 5. A primary transfer roller not shown is provided on an inner side of the intermediate transfer belt 9.

The fixing unit 50 includes a heating unit 11 heated by a heater, and a pressure roller 12 that is in pressure contact with the heating unit 11. The heating unit 11 according to the present embodiment includes a heater and a fixing film heated by the heater, but is not limited thereto. For example, the heating unit 11 may be a fixing roller having a heater built therein, or may be a fixing belt including a heating layer heated by induction heating. Various types of heaters, such as a ceramic heater or a halogen heater, may be adopted as the heater.

The sheet feeding unit 40 is disposed on a lower portion of the image forming apparatus 100, and is provided with a feeding cassette 1 that may be drawn out from and attached to an apparatus body 100A. The sheet discharging apparatus 60 includes a sheet discharge roller pair 61, and a sheet discharge tray 15 on which a sheet P discharged by the sheet discharge roller pair is supported. The sheet P includes paper such as normal paper and envelopes, plastic films such as Overhead Projector (OHP) sheets, and cloths.

Next, an image forming operation of the image forming apparatus 100 configured as above will be described. In a state where an image signal is entered from a personal computer or the like not shown to the laser scanner 8, a laser light that corresponds to the image signal is irradiated from the laser scanner 8 to the photosensitive drum 7 of the process cartridge 31Y.

In this state, a surface of the photosensitive drum 7 is charged uniformly to a predetermined polarity and potential by the charging roller 32, and by having laser light irradiated from the laser scanner 8, an electrostatic latent image is formed on the surface thereof. The electrostatic latent image formed on the photosensitive drum 7 is developed by the developing roller 33, and a yellow (Y) toner image is formed on the photosensitive drum 7.

Similarly, laser light is irradiated on the respective photosensitive drums of process cartridges 31M, 31C, and 31K from the laser scanner 8, and toner images of magenta (M), cyan (C), and black (K) are formed respectively on the photosensitive drums. The toner images of respective colors formed on the respective photosensitive drums are transferred to the intermediate transfer belt 9 by primary transfer rollers corresponding to the respective process cartridges, and conveyed to a secondary transfer roller 6 by the intermediate transfer belt 9 rotated by the driving roller 5.

The image forming processes of the respective colors are performed at timings at which each image is superposed on an upstream toner image that has been primarily transferred to the intermediate transfer belt 9. Further, after the toner images of respective colors are transferred to the intermediate transfer belt 9, toner remaining on the surface of the photosensitive drum 7 is removed by a cleaning device not shown.

In parallel with the image forming process, the sheet P stored in the feeding cassette 1 of the sheet feeding unit 40 or the sheet P fed from a manual sheet feed portion 41 is fed by a feed roller 3. The sheet P fed by the feed roller 3 is conveyed upward by a conveyance roller pair 4.

The sheet P is conveyed at a predetermined conveyance timing by the conveyance roller pair 4 at a matched timing with the image forming process. Then, a full-color toner image on the intermediate transfer belt 9 is transferred to the sheet P by a secondary transfer bias applied to the secondary transfer roller 6. The conveyance roller pair 4 may be a registration roller pair that corrects skewing of the sheet P.

Predetermined heat and pressure is applied by the heating unit 11 and the pressure roller 12 of the fixing unit 50 to the sheet P on which the toner image has been transferred, by which toner is melted and fixed. The sheet P having passed through the fixing unit 50 is discharged by the sheet discharge roller pair 61 onto the sheet discharge tray 15.

### Sheet Discharging Apparatus

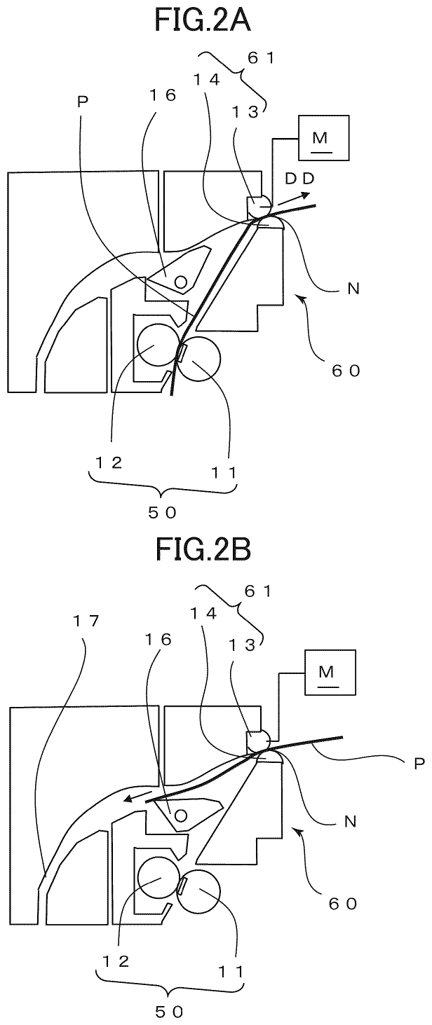

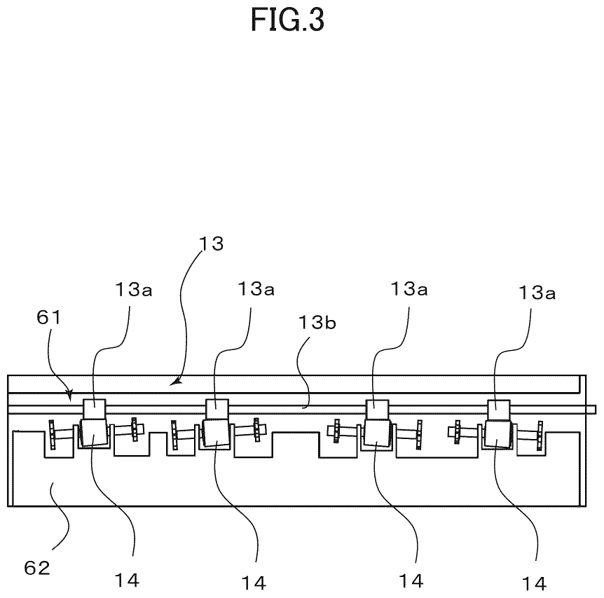

Next, the sheet discharging apparatus 60 will be described with reference to FIGS. 2A to 3. FIG. 2A is a cross-sectional view illustrating a state in which the sheet P is discharged toward the sheet discharge tray 15. FIG. 2B is a cross-sectional view illustrating a state in which the sheet P is conveyed toward a duplex conveyance path 17. FIG. 3 is a front view illustrating the sheet discharge roller pair 61.

As illustrated in FIG. 2A, when simplex printing is performed, the sheet P having passed through the fixing unit 50 is discharged to an exterior of the image forming apparatus 100 by the sheet discharge roller pair 61, and supported on the sheet discharge tray 15 (refer to FIG. 1).

Further, as illustrated in FIG. 2B, when duplex printing is performed the sheet P having an image formed on a first surface is conveyed toward the exterior of the apparatus by the sheet discharge roller pair 61. The sheet discharge roller pair 61 includes a driving roller 13 driven by a drive motor M serving as a drive source, and a driven roller 14 that is driven to rotate by the driving roller 13. The driving roller 13 may be rotated in normal and reverse directions. Further, a guide member 16 capable of changing conveyance paths of the sheet P is disposed between the fixing unit 50 and the sheet discharge roller pair 61.

In a state where the trailing edge of the sheet P passes through the guide member 16, the guide member 16 pivots, by which the conveyance path of the sheet P is switched. The driving roller 13 rotates in a reverse direction, and the sheet P is conveyed toward the duplex conveyance path 17. Thereafter, an image is formed by the image forming unit 30 on a second surface of the sheet P having passed through the duplex conveyance path 17, and the sheet P is discharged by the sheet discharge roller pair 61 onto the sheet discharge tray 15. The sheet P having been discharged to the exterior of the apparatus by the sheet discharge roller pair 61 is supported on the sheet discharge tray 15 serving as a supporting portion.

FIG. 3 is a front view in which the sheet discharge roller pair 61 is viewed in a horizontal direction. The sheet discharge roller pair 61 includes the driving roller 13 and a plurality of, four according to the present embodiment, driven rollers 14. In other words, the sheet discharge roller pair 61 includes a plurality of pushing rollers, and each of the plurality of pushing rollers is the driven roller 14. The driving roller 13 includes a drive shaft 13b driven by the drive motor M (refer to FIG. 2A), and a plurality of roller portions 13a that are fixed to the drive shaft 13b.

The respective driven rollers 14 are supported relatively movably with respect to the driving rollers 13 by a holder 62. The respective driven rollers 14 are in pressure contact with the roller portion 13a of the corresponding driving roller 13. The plurality of driven rollers 14 have similar or symmetrical shapes, such that in the following description, only one of the driven rollers 14, such as the leftmost driven roller 14 illustrated in FIG. 3, among the plurality of driven rollers 14 is described.

### Driven Roller

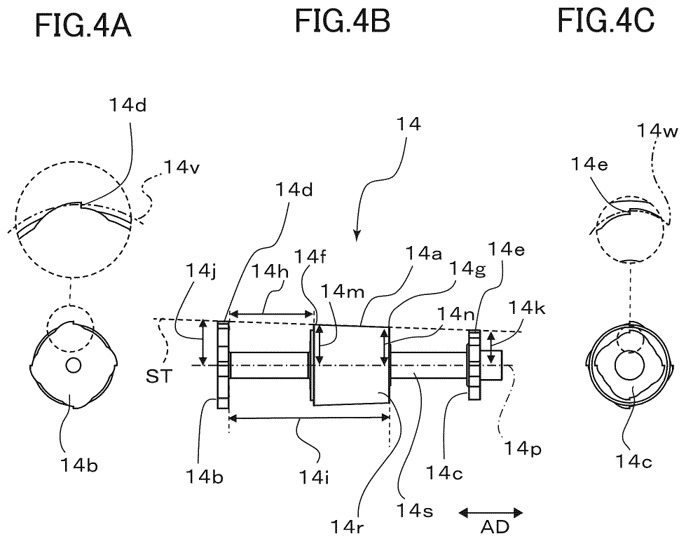

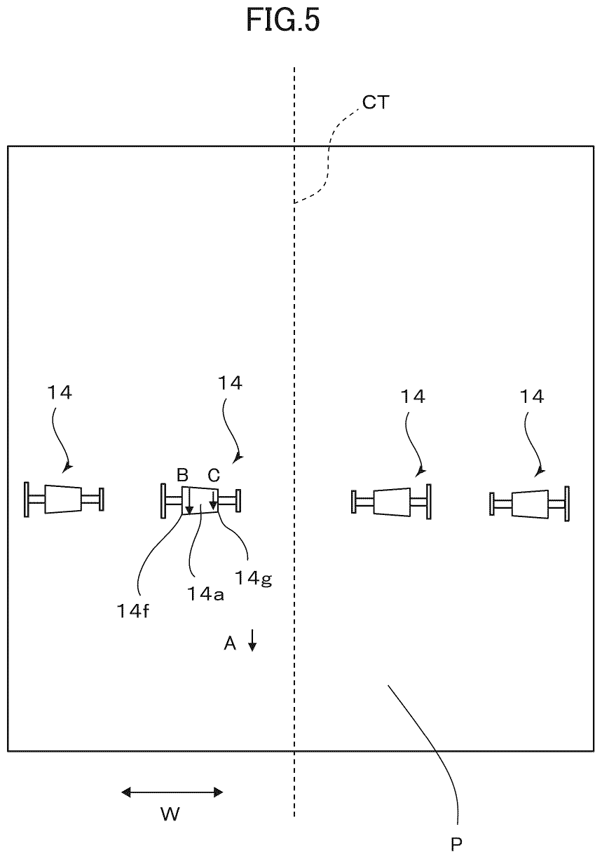

Next, the driven roller 14 will be described with reference to FIGS. 4A to 6. FIG. 4A is a left side view of the driven roller 14 and a partially enlarged view thereof, FIG. 4B is a front view illustrating the driven roller 14, and FIG. 4C is a right side view of the driven roller 14 and a partially enlarged view thereof. FIG. 5 is a view illustrating a peripheral speed of the driven roller 14 and a conveyance speed of the sheet P.

As illustrated in FIGS. 4A to 4C, the driven roller 14 includes a roller shaft 14s, a roller portion 14r serving as a first roller portion, and flange portions 14b and 14c. The roller portion 14r and the flange portions 14b and 14c are fixed to the roller shaft 14s, and they are rotated integrally about a rotational axis 14p serving as a second rotational axis of the roller shaft 14s. The roller shaft 14s may be divided into multiple shafts. In the present embodiment, the driven roller 14 is formed of resin, and the roller shaft 14s, the roller portion 14r, and the flange portions 14b and 14c are formed integrally. The driven roller 14 is formed by injection molding. The direction in which the rotational axis 14p extends may be referred to as an axial direction AD serving as a second axial direction.

The roller portion 14r of the driven roller 14 forms a discharge nip N together with the roller portion 13a of the driving roller 13, and the sheet P is discharged in a sheet discharge direction DD at the discharge nip N (refer to FIG. 2A). The roller portion 14r has a circumference surface 14a that abuts against the roller portion 13a of the driving roller 13, and that is formed in a truncated cone shape. The sheet discharge direction DD at the discharge nip N may be referred to as a movement direction of the sheet P at the discharge nip N. Therefore, the sheet discharge direction DD is parallel to a tangent line of the roller portion 13a that passes the discharge nip N. Further, the sheet discharge direction DD is parallel to a tangent line of the roller portion 14r that passes the discharge nip N.

The flange portion 14b includes a plurality of, four according to the present embodiment, first surfaces 14d that are configured to push the sheet P toward the sheet discharge tray 15. Similarly, the flange portion 14c includes a plurality of, four according to the present embodiment, second surfaces 14e that are configured to push the sheet P toward the sheet discharge tray 15. The first surfaces 14d are each an example of a pushing surface or a first pushing surface, and the second surfaces 14e are each an example of a pushing surface or a second pushing surface. The first surfaces 14d and the second surfaces 14e extend in a direction intersecting the axial direction AD of the rotational axis 14p, and they face a downstream side in a direction of rotation of the driven roller 14 in a state where the discharge nip N discharges the sheet P in the sheet discharge direction DD.

The first surfaces 14d extend in a direction intersecting a circle 14v, which is a virtual circle with the rotational axis 14p as a center, when viewed in the axial direction AD, as illustrated in FIG. 4A. In other words, when a first virtual point and a second virtual point are arranged on the first surfaces 14d when viewed in the axial direction AD, a distance between the first virtual point and the rotational axis 14p differ from the distance between the second virtual point and the rotational axis 14p.

The second surfaces 14e extend in a direction intersecting a circle 14w, which is a virtual circle with the rotational axis 14p as a center, when viewed in the axial direction AD, as illustrated in FIG. 4C. In other words, when a third virtual point and a fourth virtual point are arranged on the second surfaces 14e when viewed in the axial direction AD, a distance between the third virtual point and the rotational axis 14p differs from the distance between the fourth virtual point and the rotational axis 14p.

The circumference surface 14a of the roller portion 14r is arranged between the flange portion 14b and the flange portion 14c in the axial direction AD. In the axial direction AD, the roller portion 14r is separated from the flange portion 14b and from the flange portion 14c. In other words, a gap is formed between the roller portion 14r and the flange portion 14b and between the roller portion 14r and the flange portion 14c in the axial direction AD. Further, the circumference surface 14a serving as a first circumference surface includes a first end 14f that is positioned close to the flange portion 14b and a second end 14g that is positioned on an opposite side from the first end 14f in the axial direction AD and that is close to the flange portion 14c.

That is, a distance 14h between the first end 14f of the circumference surface 14a and the first surface 14d is shorter than a distance 14i between the second end 14g of the circumference surface 14a and the first surfaces 14d, i.e., distance 14h<distance 14i.

A rotation radius of the circumference surface 14a at the first end 14f is referred to as a first radius 14m, a rotation radius of the circumference surface 14a at the second end 14g is referred to as a second radius 14n, a rotation radius of the first surfaces 14d is referred to as a third radius 14j, and a rotation radius of the second surfaces 14e is referred to as a fourth radius 14k. The third radius 14j is a distance between the rotational axis 14p and an outermost position in a radial direction of the first surfaces 14d, and the fourth radius 14k is a distance between the rotational axis 14p and an outermost position in a radial direction of the second surfaces 14e.

In this state, the circumference surface 14a is inclined with respect to the axial direction AD such that the first radius 14m becomes greater than the second radius 14n. Further, the third radius 14j is greater than the first radius 14m, and the fourth radius 14k is smaller than the second radius 14n. That is, a dimensional relationship of the respective radii is as follows.

$$third radius 14 j > first radius 14 m > second radius 14 n > fourth radius 14 k \qquad ( 1 )$$

As illustrated in FIG. 5, the four driven rollers 14 according to the present embodiment are arranged in a bilaterally symmetrical manner with respect to a center CT of a conveyance path in a sheet width direction W orthogonal to the sheet discharge direction DD. The respective driven rollers 14 are arranged such that the second end 14g having a smaller radius is positioned closer to the center CT than the first end 14f having a greater radius. The sheet width direction W is a direction orthogonal to the sheet discharge direction DD, and is parallel to an axial direction serving as a first axial direction of the driving roller 13, that is, direction of a rotational axis 13p described later.

The number of the driven roller 14 is not necessarily four. Further, they do not need to be arranged in a strictly bilaterally symmetrical manner with respect to the center CT of the conveyance path. That is, an angle formed by the axial direction AD to the axial direction of the driving roller 13, i.e., the direction in which the rotational axis 13p described later extends, may vary among the respective driven rollers 14.

Now, one driven roller 14, such as the leftmost driven roller 14 illustrated in FIG. 3, arranged on one side with respect to the center CT of the conveyance path is referred to as a second roller, and one driven roller 14 arranged on the other side with respect to the center CT of the conveyance path, such as the rightmost driven roller 14 of FIG. 3, is referred to as a third roller. The rotation radius of the circumference surface 14a, or second circumference surface, at the first end 14f, or third end, of third roller is referred to as the first radius 14m, or fifth radius, a rotation radius of the circumference surface 14a at the second end 14g, or fourth end, is referred to as the second radius 14n, or sixth radius, the rotation radius of the first surface 14d, or third surface or second pushing surface, is referred to as the third radius 14j, or seventh radius, and the rotation radius of the second surface 14e, or fourth surface or second pushing surface, is referred to as the fourth radius 14k, or eighth radius. Furthermore, the third roller includes a roller portion 14r, serving as a second roller portion, having a circumference surface 14a that abuts against the roller portion 13a of the driving roller 13. The third roller is configured to rotate about a third rotational axis extending in a third axial direction. In this state, the circumference surface 14a is inclined with respect to the axial direction AD such that the first radius 14m becomes greater than the second radius 14n. The third radius 14j is greater than the first radius 14m, and the fourth radius 14k is smaller than the second radius 14n. Further, the second end 14g of the second roller and the second end 14g of the third roller are arranged between the first end 14f of the second roller and the first end 14f of the driven roller 14 of the third roller.

In this state, if a conveyance speed of the sheet P is referred to as a conveyance speed A, a peripheral speed of the circumference surface 14a at the first end 14f is referred to as a peripheral speed B, and a peripheral speed of the circumference surface 14a at the second end 14g is referred to as a peripheral speed C, the dimensional relationship of the conveyance speed A and the peripheral speeds B and C is as follows.

$$peripheral speed B > conveyance speed A > peripheral speed C \qquad ( 2 )$$

By configuring the driven roller 14 as described above, when the sheet P is conveyed, the conveyance speed A of the sheet P differs from the peripheral speeds B and C of the circumference surface 14a, such that the sheet P slides against the circumference surface 14a, and toner may be suppressed from being solidified on the circumference surface 14a. Therefore, it may be possible to suppress toner being solidified on the circumference surface 14a from being attached to subsequent sheets, and to suppress the soiling of the sheet by toner.

Further, by arranging the plurality of driven rollers 14 as illustrated in FIG. 5, the components of the plurality of driven rollers 14 may be used commonly, and costs may be cut down. Further, the sheets P may be conveyed while being stretched toward the outer side in the sheet width direction W, such that wrinkling of the sheets P may be suppressed.

According to the present embodiment, the respective driven rollers 14 are arranged such that the second end 14g with a smaller radius is positioned closer to the center CT than the first end 14f with a greater radius, but the arrangement is not limited thereto. For example, the respective driven rollers 14 may be arranged such that the first end 14f with a greater radius is positioned closer to the center CT than the second end 14g with a smaller radius. In that case, the first end 14f of one driven roller 14 and the first end 14f of another driven roller 14 are arranged between the second end 14g of the one driven roller 14 and the second end 14g of the another driven roller 14 with respect to the axial direction of the driving roller 13.

### Orientation of Driven Roller During Sheet Conveyance

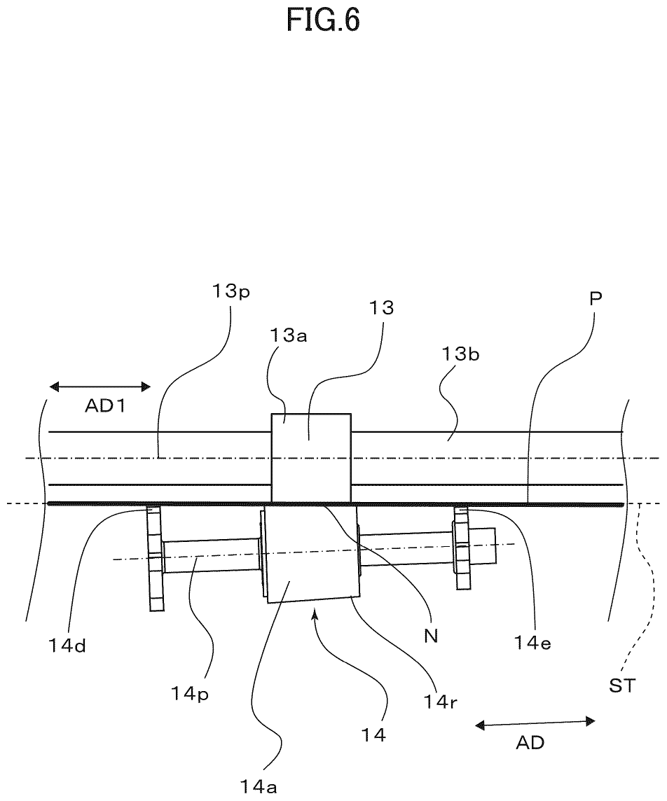

FIG. 6 is a front view illustrating an orientation of the driven roller 14 while the sheet P is conveyed. As described above, the circumference surface 14a of the roller portion 14r of the driven roller 14 is formed so as to intersect the rotational axis 14p of the driven roller 14. The roller portion 13a of the driving roller 13 rotates about the rotational axis 13p serving as a first rotational axis. Therefore, when the circumference surface 14a of the driven roller 14 abuts against the roller portion 13a of the driving roller 13, the rotational axis 14p of the driven roller 14 is inclined with respect to the rotational axis 13p of the driving roller 13. An axial direction AD1 of the rotational axis 13p may be referred to as a first axial direction. In other words, the rotational axis 13p extends in the axial direction AD1.

Then, the sheet P is conveyed by the roller portion 13a of the driving roller 13 and the roller portion 14r of the driven roller 14. When the trailing edge of the sheet P passes through the discharge nip N, either one of the first surfaces 14d and the second surfaces 14e pushes the trailing edge of the sheet P. Thereby, the trailing edge of the sheet P is suppressed from resting and being held on the circumference surface 14a of the roller portion 14r of the driven roller 14, and the sheet P may be supported on the sheet discharge tray 15 without fail. That is, the discharging property of the sheets P may be enhanced.

According to the present embodiment, the rotational axis 14p of the driven roller 14 is arranged close to the sheet discharge tray 15 in the horizontal direction than the rotational axis 13p of the driving roller 13, as illustrated in FIG. 1. Thereby, the sheet p discharged from the discharge nip N may be discharged along the inclination of the sheet discharge tray 15, and the supporting property of the sheet P on the sheet discharge tray 15 may be improved. Further, the sheet discharge port through which the sheet P is discharged is opened diagonally upward, such that air containing moisture near the discharge nip N may be easily discharged to the exterior of the apparatus body 100A, and the occurrence of dew condensations may be suppressed. Further, the rotational axis 14p is positioned below the rotational axis 13p in a vertical direction VD.

Further, supposing that the third radius 14j<the first radius 14m in FIG. 4B, the trailing edge of the sheet P may not be pushed toward the sheet discharge tray 15 by the first surfaces 14d. Further, supposing that the second radius 14n<the fourth radius 14k in FIG. 4B, the second surfaces 14e will push the sheet P nipped by the discharge nip N strongly, and may damage the sheet P.

However, according to the present embodiment, the dimensional relationship of the respective radii of the driven roller 14 is set as described in Expression (1) described above, the first surfaces 14d and the second surfaces 14e are positioned approximately on a same plane with respect to the conveyance path of the sheet P. In other words, when viewed in the sheet discharge direction DD, the first surfaces 14d and the second surfaces 14e are arranged at a position superposed with a straight line ST that passes the discharge nip N and that is parallel to the rotational axis 13p of the driving roller 13, as illustrated in FIG. 6. Thereby, the sheet discharge performance may be improved, and damages to the sheet P may be suppressed.

The arrangement of the first surfaces 14d and the second surfaces 14e may be defined as follows. As illustrated in FIG. 4B, the first surfaces 14d and the second surfaces 14e are arranged at a position superposed with the straight line ST that is parallel to the rotational axis 13p and that passes the discharge nip N when viewed in a direction orthogonal to the axial direction of the rotational axis 13p and parallel to a tangent line of the roller portion 13a passing through the discharge nip N, as illustrated in FIG. 4B.

Further, when viewed in the direction orthogonal to the axial direction AD, at least one of the first surfaces 14d and the second surfaces 14e is arranged at a position superposed with the straight line that is parallel to the circumference surface 14a and that passes the circumference surface 14a (refer to FIG. 4B).

### Second Embodiment

Next, a second embodiment of the present invention will be described. The second embodiment adopts a configuration in which the flange portion 14c of the driven roller 14 according to the first embodiment is omitted. Therefore, configurations similar to the first embodiment are either not shown or denoted with the same reference numbers.

### Driven Roller

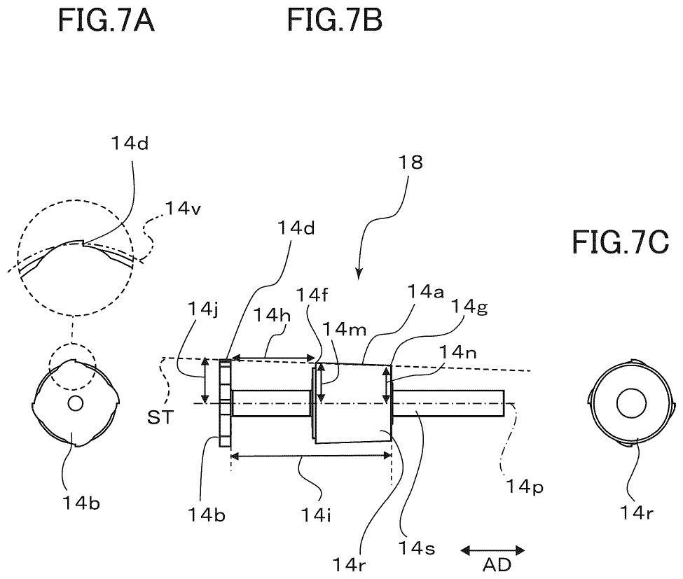

With reference to FIGS. 7A to 7C, a driven roller 18 according to a second embodiment will be described. As described above, the driven roller 18 adopts a configuration in which the flange portion 14c is omitted from the driven roller 14 of the first embodiment. FIG. 7A is a left side view illustrating the driven roller 18 and a partially enlarged view thereof, FIG. 7B is a front view of the driven roller 18, and FIG. 7C is a right side view of the driven roller 18.

As illustrated in FIGS. 7A to 7C, the driven roller 18 serving as a second roller includes the roller shaft 14s, the roller portion 14r, and the flange portion 14b. The roller portion 14r and the flange portion 14b are fixed to the roller shaft 14s, and rotate integrally about the rotational axis 14p of the roller shaft 14s. The roller shaft 14s may be divided into multiple shafts. In the present embodiment, the driven roller 18 is formed of resin, and includes the roller shaft 14s, the roller portion 14r, and the flange portion 14b which are formed integrally. The driven roller 18 is formed by injection molding.

The circumference surface 14a of the roller portion 14r is arranged at a position different from the flange portion 14b in the axial direction AD. Further, the circumference surface 14a includes the first end 14f that is close to the flange portion 14b, and the second end 14g that is positioned on an opposite side from the first end 14f in the axial direction AD and that is positioned far from the flange portion 14b than the first end 14f.

That is, the distance 14h between the first end 14f of the circumference surface 14a and the first surfaces 14d is shorter than the distance 14i between the second end 14g of the circumference surface 14a and the first surfaces 14d, that is, distance 14h<distance 14i.

The rotation radius of the circumference surface 14a at the first end 14f is referred to as the first radius 14m, the rotation radius of the circumference surface 14a at the second end 14g is referred to as the second radius 14n, and the rotation radius of the first surfaces 14d is referred to as the third radius 14j.

In this state, the circumference surface 14a is inclined with respect to the axial direction AD such that the first radius 14m becomes greater than the second radius 14n. Further, the third radius 14j as the rotation radius is greater than the first radius 14m. That is, the dimensional relationship of the respective radii is as follows.

$$third radius 14 j > first radius 14 m > second radius 14 n \qquad ( 3 )$$

As described, the driven roller 18 according to the second embodiment includes only one flange portion 14b, such that the fabrication of components when forming the driven roller 18 using a mold may be facilitated, and costs may be cut down. Further, similar to the first embodiment, the sheet discharging property may be enhanced and damaging of the sheets P may be suppressed.

### Third Embodiment

Next, a third embodiment of the present invention will be described. The third embodiment adopts a configuration in which the flange portion 14b of the driven roller 14 according to the first embodiment is omitted. Therefore, configurations similar to the first embodiment are either not shown or denoted with the same reference numbers.

### Driven Roller

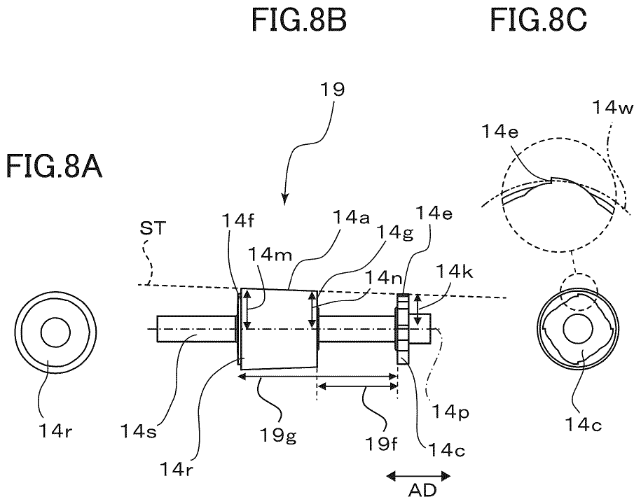

With reference to FIGS. 8A to 8C, a driven roller 19 according to a third embodiment will be described. As described above, the driven roller 19 adopts a configuration in which the flange portion 14b is omitted from the driven roller 14 of the first embodiment. FIG. 8A is a left side view illustrating the driven roller 19, FIG. 8B is a front view of the driven roller 19, and FIG. 8C is a right side view of the driven roller 19 and a partially enlarged view thereof.

As illustrated in FIGS. 8A to 8C, the driven roller 19 serving as a second roller includes the roller shaft 14s, the roller portion 14r, and the flange portion 14c. The roller portion 14r and the flange portion 14c are fixed to the roller shaft 14s, and rotate integrally about the rotational axis 14p of the roller shaft 14s. The roller shaft 14s may be divided into multiple shafts. In the present embodiment, the driven roller 19 is formed of resin, and includes the roller shaft 14s, the roller portion 14r, and the flange portion 14c which are formed integrally. The driven roller 19 is formed by injection molding.

The circumference surface 14a of the roller portion 14r is arranged at a position different from the flange portion 14c in the axial direction AD. Further, the circumference surface 14a includes the first end 14f, and the second end 14g that is positioned on an opposite side from the first end 14f in the axial direction AD and that is positioned close to the flange portion 14c than the first end 14f.

That is, a distance 19g between the first end 14f of the circumference surface 14a and the second surfaces 14e is longer than a distance 19f between the second end 14g of the circumference surface 14a and the second surfaces 14e, that is, distance 19g>distance 19f.

The rotation radius of the circumference surface 14a at the first end 14f is referred to as the first radius 14m, the rotation radius of the circumference surface 14a at the second end 14g is referred to as the second radius 14n, and the rotation radius of the second surfaces 14e is referred to as the fourth radius 14k.

In this state, the circumference surface 14a is inclined with respect to the axial direction AD such that the first radius 14m becomes greater than the second radius 14n. Further, the fourth radius 14k as the rotation radius is smaller than the second radius 14n. That is, the dimensional relationship of the respective radii is as follows.

$$first radius 14 m > second radius 14 n > fourth radius 14 k \qquad ( 4 )$$

As described, the driven roller 19 according to the third embodiment includes only one flange portion 14c, such that the fabrication of components when forming the driven roller 19 using a mold may be facilitated, and costs may be cut down. Further, similar to the first embodiment, the sheet discharging property may be enhanced and damaging of the sheets P may be suppressed.

### Fourth Embodiment

Next, a fourth embodiment of the present invention will be described. The fourth embodiment adopts a configuration in which the flange portions 14b and 14c of the driven roller 14 according to the first embodiment respectively have pushing surfaces 20f and 20g added thereto. Therefore, configurations similar to the first embodiment are either not shown or denoted with the same reference numbers.

### Driven Roller

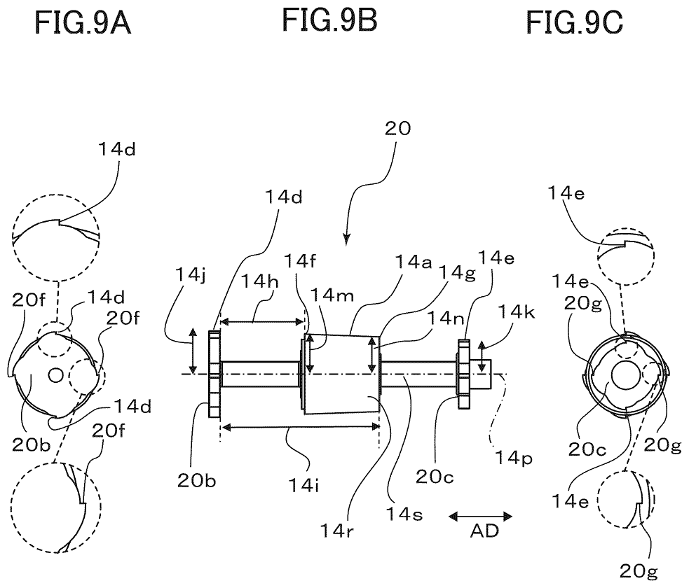

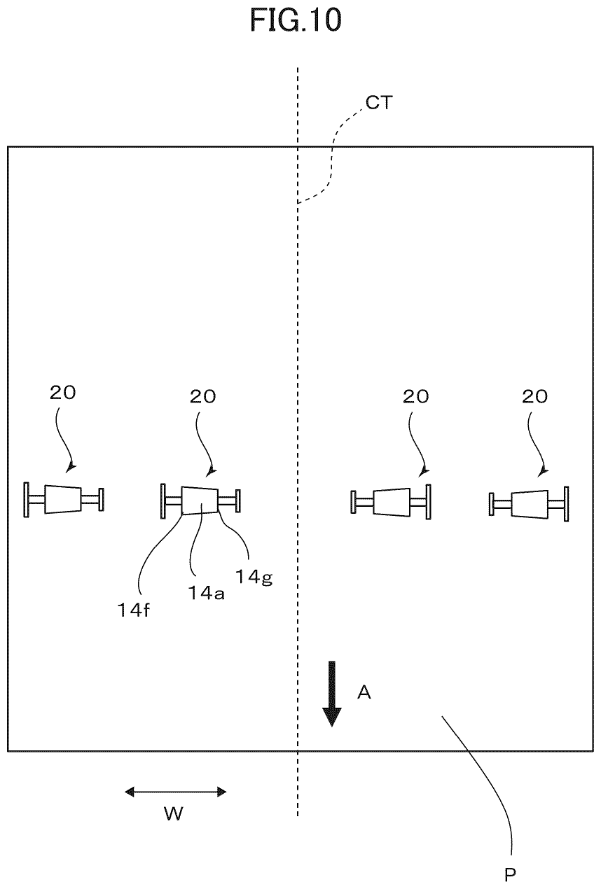

With reference to FIGS. 9A to 9C and FIG. 10, a driven roller 20 according to a fourth embodiment will be described. FIG. 9A is a left side view illustrating the driven roller 20 and a partially enlarged view thereof, FIG. 9B is a front view of the driven roller 20, and FIG. 9C is a right side view of the driven roller 20 and a partially enlarged view thereof. FIG. 10 is a view illustrating a positional relationship of the four driven rollers 20.

As illustrated in FIGS. 9A to 9C, the driven roller 20 serving as a second roller includes the roller shaft 14s, the roller portion 14r, and flange portions 20b and 20c. As described above, the driven roller 20 according to the fourth embodiment has the pushing surfaces 20f and 20g added to the driven roller 14 according to the first embodiment.

More specifically, the flange portion 20b according to the present embodiment includes two first surfaces 14d and two pushing surfaces 20f. The first surfaces 14d and the pushing surfaces 20f are alternately arranged at 90-degree intervals in the direction of rotation of the flange portion 20b.

Further, the flange portion 20c includes two second surfaces 14e and two pushing surfaces 20g. The second surfaces 14e and the pushing surfaces 20g are alternately arranged at 90-degree intervals in the direction of rotation of the flange portion 20c.

The pushing surfaces 20f and 20g as surfaces extend in a direction intersecting the axial direction AD, and in a state where the discharge nip N discharges a sheet in the sheet discharge direction DD (refer to FIG. 2A), the surfaces face the upstream side in the direction of rotation of the driven roller 20. Further, the pushing surfaces 20f are arranged to face the first surfaces 14d in the rotational direction of the driven roller 20. Similarly, the pushing surfaces 20g are arranged to face the second surfaces 14e in the direction of rotation of the driven roller 20.

The rotation radius of the pushing surfaces 20f is the third radius 14j, similar to the first surfaces 14d, and the rotation radius of the pushing surfaces 20g is the fourth radius 14k, similar to the second surfaces 14e. The present embodiment also satisfies the dimensional relationship of the respective radii shown in Expression (1) described in the first embodiment.

As illustrated in FIG. 10, the four driven rollers 20 according to the present embodiment are arranged bilaterally symmetrically with respect to the center CT of the conveyance path. Therefore, if the driven roller 20 illustrated in FIG. 9B is to be applied to the two driven rollers 20 arranged on the right side in FIG. 10, the driven roller 20 must be reversed in the right-left direction from the orientation of FIG. 9B. Then, in a state where the discharge nip N discharges a sheet in the sheet discharge direction DD, the first surfaces 14d and the second surfaces 14e will face the upstream side in the rotational direction of the driven roller 20.

Therefore, according to the present embodiment, the pushing surfaces 20f and 20g that respectively face the opposite side from the first surfaces 14d and the second surfaces 14e are disposed on the flange portions 20b and 20c of the driven roller 20. Therefore, the two driven rollers 20 on the left side with respect to the center CT of the conveyance path in FIG. 10 and the two driven rollers 20 on the right side with respect to the center CT may be formed from the same components.

As described, by adopting a common design for components, costs may be cut down. Further, similar to the first embodiment, the sheet discharge performance may be improved, and damages to the sheet P may be suppressed.

According to the present embodiment, the respective driven rollers 14 are arranged such that the second end 14g having a smaller radius is disposed closer to the center CT than the first end 14f having a grater radius, but the present technique is not limited thereto. For example, the respective driven rollers 14 may be arranged such that the first end 14f having a greater radius is disposed closer to the center CT than the second end 14g having a smaller radius.

### OTHER EMBODIMENTS

In any of the embodiments described above, the first surfaces 14d and the second surfaces 14e extend in a direction orthogonal to the direction of rotation of the flange portions 14b and 14c, but the present technique is not limited thereto. For example, the first surfaces 14d and the second surfaces 14e may be inclined with respect to the direction of rotation of the flange portions 14b and 14c, as long as the first surfaces 14d and the second surfaces 14e extend in a direction intersecting the axial direction AD. Further, the pushing surfaces 20f and 20g according to the fourth embodiment may be inclined with respect to the direction of rotation of the flange portions 14b and 14c, as long as the pushing surfaces 20f and 20g extend in a direction intersecting the axial direction AD.

In any of the embodiments described above, the image forming apparatus 100 adopting an electrophotographic system has been described as an example, but the present invention is not limited thereto. For example, the present invention may be applied to an ink-jet image forming apparatus in which images are formed on the sheet by ejecting ink through nozzles.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-007090, filed Jan. 19, 2024 and Japanese Patent Application No. 2024-214478, filed Dec. 9, 2024, which are hereby incorporated by reference herein in their entirety.

What is claimed is:

1. A sheet discharging apparatus comprising:
a supporting portion configured to support a sheet;
a first roller configured to rotate about a first rotational axis extending in a first axial direction; and
a second roller configured to rotate about a second rotational axis extending in a second axial direction and configured to discharge the sheet, together with the first roller, toward the supporting portion,
wherein the second roller includes:
a first surface that extends in a direction intersecting a virtual circle having the second rotational axis as a center when viewed in the second axial direction, the first surface being configured to push the sheet toward the supporting portion;
a second surface that extends in a direction intersecting a virtual circle having the second rotational axis as the center when viewed in the second axial direction, the second surface being configured to push the sheet toward the supporting portion; and
a roller portion that is arranged between the first surface and the second surface in the second axial direction, and that includes a circumference surface configured to abut against the first roller such that a discharge nip is formed with the first roller,
wherein the circumference surface includes a first end, and a second end opposite to the first end in the second axial direction,
wherein a distance between the first end and the first surface in the second axial direction is shorter than a distance between the second end and the first surface in the second axial direction, and
wherein, in a state where a rotation radius of the circumference surface at the first end is referred to as a first radius, a rotation radius of the circumference surface at the second end is referred to as a second radius, a rotation radius of the first surface is referred to as a third radius, and a rotation radius of the second surface is referred to as a fourth radius,
(i) the circumference surface is inclined with respect to the second axial direction such that the first radius is greater than the second radius,
(ii) the third radius is greater than the first radius, and
(iii) the fourth radius is smaller than the second radius.

2. The sheet discharging apparatus according to claim 1, wherein, when viewed in a direction parallel to a tangent line, of the first roller, that is orthogonal to the first axial direction and that passes the discharge nip, the first surface and the second surface are arranged such that the first surface and the second surface are superposed with a straight line that is parallel to the first rotational axis and that passes the discharge nip.

3. The sheet discharging apparatus according to claim 1, wherein the second roller includes a surface that is arranged at a position different from the roller portion in the second axial direction, and
wherein the surface is configured to extend in a direction intersecting the second axial direction, and is configured to face an upstream side in a rotational direction in which the second roller rotates while discharging the sheet toward the supporting portion together with the first roller.

4. The sheet discharging apparatus according to claim 1, further comprising a third roller configured to rotate about a third rotational axis extending in a third axial direction, and configured to discharge the sheet, together with the first roller, toward the supporting portion,
wherein the circumference surface and the roller portion are a first circumference surface and a first roller portion, respectively,
wherein the third roller includes:
a third surface that extends in a direction intersecting a virtual circle having the third rotational axis as a center when viewed in the third axial direction, the third surface being configured to push the sheet toward the supporting portion;
a fourth surface that extends in a direction intersecting a virtual circle having the third rotational axis as the center when viewed in the third axial direction, the fourth surface being configured to push the sheet toward the supporting portion; and
a second roller portion that is arranged between the third surface and the fourth surface in the third axial direction, and that includes a second circumference surface configured to abut against the first roller,
wherein the second circumference surface includes a third end, and a fourth end opposite to the third end in the third axial direction,
wherein a distance between the third end and the third surface in the third axial direction is shorter than a distance between the fourth end and the third surface in the third axial direction, and
wherein, in a state where a rotation radius of the second circumference surface at the third end is referred to as a fifth radius, a rotation radius of the second circumference surface at the fourth end is referred to as a sixth radius, a rotation radius of the third surface is referred to as a seventh radius, and a rotation radius of the fourth surface is referred to as an eighth radius,
(i) the second circumference surface is inclined with respect to the third axial direction such that the fifth radius is greater than the sixth radius,
(ii) the seventh radius is greater than the fifth radius, and
(iii) the eighth radius is smaller than the sixth radius, and
wherein the second end of the second roller and the fourth end of the third roller are arranged between the first end of the second roller and the third end of the third roller in the first axial direction.

5. The sheet discharging apparatus according to claim 1, wherein the second roller is configured relatively movably with respect to the first roller.

6. The sheet discharging apparatus according to claim 1, further comprising a drive source configured to drive the first roller,
wherein the second roller is driven to be rotated by abutting against the first roller.

7. The sheet discharging apparatus according to claim 1, wherein the second rotational axis is closer to the supporting portion in a horizontal direction than the first rotational axis.

8. The sheet discharging apparatus according to claim 1, wherein the second rotational axis is positioned below the first rotational axis in a vertical direction.

9. An image forming apparatus comprising:
an image forming unit configured to form an image on a sheet; and
the sheet discharging apparatus according to claim 1 configured to discharge the sheet on which the image has been formed by the image forming unit.

10. A sheet discharging apparatus comprising:
a supporting portion configured to support a sheet;
a first roller configured to rotate about a first rotational axis extending in a first axial direction; and
a second roller configured to rotate about a second rotational axis extending in a second axial direction and configured to discharge the sheet toward the supporting portion together with the first roller,
wherein the second roller includes:
a pushing surface that extends in a direction intersecting a virtual circle having the second rotational axis as a center when viewed in the second axial direction, the pushing surface being configured to push the sheet toward the supporting portion; and
a roller portion that is arranged at a position different from the pushing surface in the second axial direction, and that includes a circumference surface configured to abut against the first roller such that a discharge nip is formed with the first roller,
wherein the circumference surface includes a first end, and a second end opposite to the first end in the second axial direction,
wherein a distance between the first end and the pushing surface in the second axial direction is shorter than a distance between the second end and the pushing surface in the second axial direction, and
wherein, in a state where a rotation radius of the circumference surface at the first end is referred to as a first radius, and a rotation radius of the circumference surface at the second end is referred to as a second radius,
(i) the circumference surface is inclined with respect to the second axial direction such that the first radius is greater than the second radius, and
(ii) a rotation radius of the pushing surface is greater than the first radius.

11. The sheet discharging apparatus according to claim 10, wherein, when viewed in a direction parallel to a tangent line, of the first roller, that is orthogonal to the first axial direction and that passes the discharge nip, the pushing surface is arranged such that the pushing surface is superposed with a straight line that is parallel to the first rotational axis and that passes the discharge nip.

12. The sheet discharging apparatus according to claim 10, wherein the second roller includes a surface that is arranged at a position different from the roller portion in the second axial direction, and
wherein the surface is configured to extend in a direction intersecting the second axial direction, and is configured to face an upstream side in a rotational direction in which the second roller rotates while discharging the sheet toward the supporting portion together with the first roller.

13. The sheet discharging apparatus according to claim 10, further comprising a third roller configured to rotate about a third rotational axis extending in a third axial direction, and configured to discharge the sheet, together with the first roller, toward the supporting portion,
wherein the pushing surface, the circumference surface, and the roller portion are a first pushing surface, a first circumference surface, and a first roller portion, respectively,
wherein the third roller includes:
a second pushing surface that extends in a direction intersecting a virtual circle having the third rotational axis as a center when viewed in the third axial direction, the second pushing surface being configured to push the sheet toward the supporting portion; and
a second roller portion that is arranged at a position different from the second pushing surface in the third axial direction, and that includes a second circumference surface configured to abut against the first roller,
wherein the second circumference surface includes a third end, and a fourth end opposite to the third end in the third axial direction,
wherein a distance between the third end and the second pushing surface in the third axial direction is shorter than a distance between the fourth end and the second pushing surface in the third axial direction, and
wherein, in a state where a rotation radius of the second circumference surface at the third end is referred to as a fifth radius, and a rotation radius of the second circumference surface at the fourth end is referred to as a sixth radius,
(i) the second circumference surface is inclined with respect to the third axial direction such that the fifth radius is greater than the sixth radius, and
(ii) a rotation radius of the second pushing surface is greater than the fifth radius, and
wherein the second end of the second roller and the fourth end of the third roller are arranged between the first end of the second roller and the third end of the third roller in the first axial direction.

14. The sheet discharging apparatus according to claim 10, wherein the second roller is configured relatively movably with respect to the first roller.

15. The sheet discharging apparatus according to claim 10, further comprising a drive source configured to drive the first roller,
wherein the second roller is driven to be rotated by abutting against the first roller.

16. The sheet discharging apparatus according to claim 10, wherein the second rotational axis is closer to the supporting portion in a horizontal direction than the first rotational axis.

17. The sheet discharging apparatus according to claim 10, wherein the second rotational axis is positioned below the first rotational axis in a vertical direction.

18. An image forming apparatus comprising:
an image forming unit configured to form an image on a sheet; and
the sheet discharging apparatus according to claim 10 configured to discharge the sheet on which the image has been formed by the image forming unit.

19. A sheet discharging apparatus comprising:
a supporting portion configured to support a sheet;
a first roller configured to rotate about a first rotational axis extending in a first axial direction; and
a second roller configured to rotate about a second rotational axis extending in a second axial direction and configured to discharge the sheet toward the supporting portion together with the first roller,
wherein the second roller includes:
a pushing surface that extends in a direction intersecting a virtual circle having the second rotational axis as a center when viewed in the second axial direction, the pushing surface being configured to push the sheet toward the supporting portion; and
a roller portion that is arranged at a position different from the pushing surface in the second axial direction, and that includes a circumference surface configured to abut against the first roller such that a discharge nip is formed with the first roller,
wherein the circumference surface includes a first end, and a second end opposite to the first end in the second axial direction,
wherein a distance between the first end and the pushing surface in the second axial direction is longer than a distance between the second end and the pushing surface in the second axial direction, and
wherein, in a state where a rotation radius of the circumference surface at the first end is referred to as a first radius, and a rotation radius of the circumference surface at the second end is referred to as a second radius,
(i) the circumference surface is inclined with respect to the second axial direction such that the first radius is greater than the second radius, and
(ii) a rotation radius of the pushing surface is smaller than the second radius.

20. The sheet discharging apparatus according to claim 19, wherein, when viewed in a direction parallel to a tangent line of the first roller that is orthogonal to the first axial direction and that passes the discharge nip, the pushing surface is arranged such that the pushing surface is superposed with a straight line that is parallel to the first rotational axis and that passes the discharge nip.

21. The sheet discharging apparatus according to claim 19, wherein the second roller includes a surface that is arranged at a position different from the roller portion in the second axial direction, and
wherein the surface is configured to extend in a direction intersecting the second axial direction, and is configured to face an upstream side in a rotational direction in which the second roller rotates while discharging the sheet toward the supporting portion together with the first roller.

22. The sheet discharging apparatus according to claim 19, further comprising a third roller configured to rotate about a third rotational axis extending in a third axial direction, and configured to discharge the sheet, together with the first roller, toward the supporting portion,
wherein the pushing surface, the circumference surface, and the roller portion are a first pushing surface, a first circumference surface, and a first roller portion, respectively,
wherein the third roller includes:
a second pushing surface that extends in a direction intersecting a virtual circle having the third rotational axis as a center when viewed in the third axial direction, and that is configured to push the sheet toward the supporting portion; and
a second roller portion that is arranged at a position different from the second pushing surface in the third axial direction, and that includes a second circumference surface configured to abut against the first roller,
wherein the second circumference surface includes a third end, and a fourth end opposite to the third end in the third axial direction,
wherein a distance between the third end and the second pushing surface in the third axial direction is longer than a distance between the fourth end and the second pushing surface in the third axial direction, and
wherein, in a state where a rotation radius of the second circumference surface at the third end is referred to as a fifth radius, and a rotation radius of the second circumference surface at the fourth end is referred to as a sixth radius,
(i) the second circumference surface is inclined with respect to the third axial direction such that the fifth radius is greater than the sixth radius, and
(ii) a rotation radius of the second pushing surface is smaller than the sixth radius, and
wherein the second end of the second roller and the fourth end of the third roller are arranged between the first end of the second roller and the third end of the third roller in the first axial direction.

23. The sheet discharging apparatus according to claim 19, wherein the second roller is configured relatively movably with respect to the first roller.

24. The sheet discharging apparatus according to claim 19, further comprising a drive source configured to drive the first roller,
wherein the second roller is driven to be rotated by abutting against the first roller.

25. The sheet discharging apparatus according to claim 19, wherein the second rotational axis is closer to the supporting portion in a horizontal direction than the first rotational axis.

26. The sheet discharging apparatus according to claim 19, wherein the second rotational axis is positioned below the first rotational axis in a vertical direction.

27. An image forming apparatus comprising:
an image forming unit configured to form an image on a sheet; and
the sheet discharging apparatus according to claim 19 configured to discharge the sheet on which the image has been formed by the image forming unit.
